(19) United States
(12) Patent Application Publication
(10) Pub. No.: US 2015/0141113 A1
(43) Pub. Date: May 21, 2015

(54) ELECTRONIC GAMING DEVICE WITH AMBIENT LIGHTING FUNCTIONALITY

(71) Applicants: Scott Melnick, Decatur, GA (US); Sigmund Lee, Atlanta, GA (US)

(72) Inventors: Scott Melnick, Decatur, GA (US); Sigmund Lee, Atlanta, GA (US)

(73) Assignee: CADILLAC JACK, Duluth, GA (US)

(21) Appl. No.: 14/084,069

(22) Filed: Nov. 19, 2013

(51) Int. Cl. G07F 17/34

(52) U.S. Cl. CPC G07F 17/34
USPC 463/20

(57) ABSTRACT

Examples disclosed herein relate to systems and methods for utilizing one or more presentations and one or more ambient light shows. The electronic gaming device may include a plurality of reels. The plurality of reels may include one or more areas. The electronic gaming device may include a memory and one or more processors. The memory may include one or more ambient lighting modules, one or more presentation modules, and/or one or more synchronization modules. The electronic gaming device may include one or more ambient light sensors and/or one or more light emitters. Further, the one or more processors may display one or more presentations and initiate one or more ambient light shows.

### FIELD

The subject matter disclosed herein relates to an electronic gaming systems and methods for providing ambient lighting functionality on a gaming machine. More specifically, the disclosure relates to systems, devices, and methods, which provide one or more ambient lighting functionalities to enhance the game playing experience for one or more players.

### INFORMATION

The gaming industry has numerous casinos located both worldwide and in the United States. A client of a casino or other gaming entity can gamble via various games of chance. For example, craps, roulette, baccarat, blackjack, and electronic or electromechanical games (e.g., a slot machine, a video poker machine, and the like) where a person may gamble on an outcome.

Paylines of an electronic gaming device (e.g., a slot machine) are utilized to determine when predetermined winning symbol combinations are aligned in a predetermined pattern to form a winning combination. A winning event occurs when the player successfully matches the predetermined winning symbols in one of the predetermined patterns.

A player's entertainment while playing one or more games may be enhanced by utilizing one or more ambient lighting game play functionalities on the gaming device. By increasing the player's entertainment level, the player's enjoyment of the game may be enhanced, which may increase a player's game playing period.

### BRIEF DESCRIPTION OF THE FIGURES

Non-limiting and non-exhaustive examples will be described with reference to the following figures, wherein like reference numerals refer to like parts throughout the various figures.

FIG. 1 is an illustration of the electronic gaming device, according to one embodiment.

FIG. 2 is an illustration of an electronic gaming system, according to one embodiment.

FIG. 3 is a block diagram of the electronic gaming device, according to one embodiment.

FIG. 4 is another block diagram of the electronic gaming device, according to one embodiment.

FIG. 5A is a diagram of gaming machine, according to one embodiment.

FIG. 5B is a diagram of a gaming machine with one or more ambient lighting functionalities, according to various embodiments.

FIG. 5C is another diagram of a gaming machine with one or more ambient lighting functionalities, according to various embodiments.

FIG. 5D is another diagram of a gaming machine with one or more ambient lighting functionalities, according to various embodiments.

FIG. 5E is another diagram of a gaming machine with one or more ambient lighting functionalities, according to various embodiments.

FIG. 5F is another diagram of a gaming machine with one or more ambient lighting functionalities, according to various embodiments.

FIG. 6A is a diagram illustrating various ambient lighting functionalities, according to various embodiments.

FIG. 6B is another diagram illustrating various ambient lighting functionalities, according to various embodiments.

FIG. 6C is another diagram illustrating various ambient lighting functionalities, according to various embodiments.

FIG. 6D is another diagram illustrating various ambient lighting functionalities, according to various embodiments.

FIG. 7 is another diagram illustrating various ambient lighting functionalities, according to various embodiments.

FIG. 8 is a flow diagram for game play, according to one embodiment.

FIG. 9 is another flow diagram for game play, according to one embodiment.

FIG. 10 is another flow diagram for game play, according to one embodiment.

FIG. 11 is another flow diagram for game play, according to one embodiment.

FIG. 12 is another diagram illustrating various ambient lighting functionalities, according to various embodiments.

### DETAILED DESCRIPTION

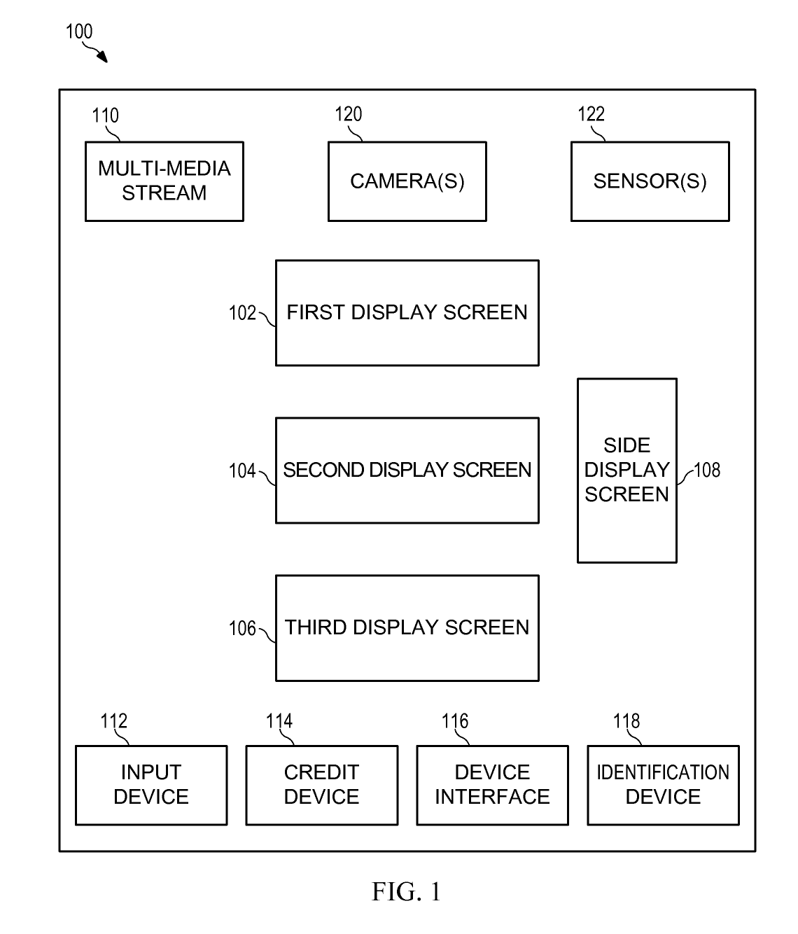

FIG. 1 is an illustration of an electronic gaming device 100. Electronic gaming device 100 may include a multi-media stream 110, a first display screen 102, a second display screen 104, a third display screen 106, a side display screen 108, an input device 112, a credit device 114, a device interface 116, an identification device 118, one or more cameras 120, and/or one or more sensors 122. Electronic gaming device 100 may display one, two, a few, or a plurality of multi-media streams 110, which may be obtained from one or more gaming tables, one or more electronic gaming devices, a central server, a video server, a music server, an advertising server, another data source, and/or any combination thereof.

Multi-media streams may be obtained for an entertainment event, a wagering event, a promotional event, a promotional offering, an advertisement, a sporting event, any other event, and/or any combination thereof. For example, the entertainment event may be a concert, a show, a television program, a movie, an Internet event, and/or any combination thereof. In another example, the wagering event may be a poker tournament, a horse race, a car race, and/or any combination thereof. The advertisement may be an advertisement for a casino, a restaurant, a shop, any other entity, and/or any combination thereof. The sporting event may be a football game, a baseball game, a hockey game, a basketball game, any other sporting event, and/or any combination thereof. These multi-media streams may be utilized in combination with the gaming table video streams.

Input device 112 may be mechanical buttons, electronic buttons, mechanical switches, electronic switches, optical switches, a slot pull handle, a keyboard, a keypad, a touch screen, a gesture screen, a joystick, a pointing device (e.g., a mouse), a virtual (on-screen) keyboard, a virtual (on-screen) keypad, biometric sensor, or any combination thereof. Input device 112 may be utilized to make a wager, to select one or more ambient light functionalities, to obtain player's point balances, to obtain any player point data, to control any object, to select one or more pattern gaming options, to obtain data relating to historical payouts, to select a row and/or column to move, to select a row area to move, to select a column area to move, to select a symbol (or image) to move, to modify electronic gaming device 100 (e.g., change sound level, configuration, font, language, etc.), to select a movie or song, to select live multi-media streams, to request services (e.g., drinks, slot attendant, manager, etc.), to select two-dimensional (“2D”) game play, to select three-dimensional (“3D”) game play, to select both two-dimensional and three-dimensional game play, to change the orientation of games in a three-dimensional space, to move a symbol (e.g., wild, multiplier, etc.), and/or any combination thereof. These selections may occur via any other input device (e.g., a touch screen, voice commands, etc.). Input device 112 may be any control panel.

Credit device 114 may be utilized to collect monies and distribute monies (e.g., cash, vouchers, etc.). Credit device 114 may interface with a mobile device to electronically transmit money and/or credits. Credit device 114 may interface with a player's card to exchange player points.

Device interface 116 may be utilized to interface electronic gaming device 100 to a bonus game device, a local area progressive controller, a wide area progressive controller, a progressive sign controller, a peripheral display device, signage, a promotional device, network components, a local network, a wide area network, remote access equipment, a slot monitoring system, a slot player tracking system, the Internet, a server, and/or any combination thereof.

Device interface 116 may be utilized to connect a player to electronic gaming device 100 through a mobile device, card, keypad, identification device 118, and/or any combination thereof. Device interface 116 may include a docking station by which a mobile device is plugged into electronic gaming machine 100. Device interface 116 may include an over the air connection by which a mobile device is connected to electronic gaming machine 100 (e.g., Bluetooth, Near Field technology, and/or Wi-Fi technology). Device interface 116 may include a connection to identification device 118.

Identification device 118 may be utilized to determine an identity of a player. Based on information obtained by identification device 118, electronic gaming device 100 may be reconfigured. In another example, the language, sound level, music, placement of multi-media streams, one or more game functionalities (e.g., game type 1, game type 2, game type 3, etc.) may be presented, a repeat payline gaming option may be presented, a pattern gaming option may be presented, historical gaming data may be presented, a row rearrangement option may be presented, a column rearrangement option may be presented, a row area rearrangement option may be presented, a column area rearrangement option may be presented, a two-dimensional gaming option may be presented, a three-dimensional gaming option may be presented, and/or the placement of gaming options may be modified based on player preference data. For example, the player may only want to play games that include ambient light gaming options only. Therefore, only games which include ambient light gaming options would be presented to the player. In another example, the player may only want to play games that include historical information relating to game play. Therefore, only games which include historical gaming data would be presented to the player. These examples may be combined.

Identification device 118 may utilize biometrics (e.g., thumb print, retinal scan, or other biometric). Identification device 118 may include a card entry slot into input device 112. Identification device 118 may include a keypad with an assigned pin number for verification. Identification device 118 may include multiple layers of identification for added security. For example, a player could be required to enter a player tracking card, and/or a pin number, and/or a thumb print, and/or any combination thereof. Based on information obtained by identification device 118, electronic gaming device 100 may be reconfigured. For example, the language, sound level, music, placement of video streams, placement of images, and the placement of gaming options utilized may be modified based on a player's preference data. For example, a player may have selected baseball under the sporting event preferences; electronic gaming device 100 will then automatically display the current baseball game onto side display screen 108 and/or an alternate display screen as set in the player's options.

First display screen 102 may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology. First display screen 102 may be used for displaying primary games or secondary (bonus) games, to display that the electronic gaming machine supports universal player cards, to display one or more warnings relating to game security, advertising, player attractions, electronic gaming device 100 configuration parameters and settings, game history, accounting meters, events, alarms, and/or any combination thereof. Second display screen 104, third display screen 106, side display screen 108, and any other screens may utilize the same technology as first display screen 102 and/or any combination of technologies.

First display screen 102 may also be virtually combined with second display screen 104. Likewise second display screen 104 may also be virtually combined with third display screen 106. First display screen 102 may be virtually combined with both second display screen 104 and third display screen 106. Any combination thereof may be formed.

For example, a single large image could be partially displayed on second display screen 104 and partially displayed on third display screen 106, so that when both display screens are put together they complete one image. Electronic gaming device 100 may stream or play prerecorded multi-media data, which may be displayed on any display combination.

One or more cameras 120 and/or one or more sensors 122 may be utilized as one or more depth image sensing devices, which may be located in various locations, including but not limited to, above the base display, above second display, in one or more locations on gaming cabinet front, on a side of the gaming cabinet other than gaming cabinet front, and/or any other location.

In one embodiment, electronic gaming device 100 may not include separate one or more input devices, but instead may only utilize one or more depth image sensing devices. In another embodiment, a player may utilize one or more input devices and/or may utilize gestures that electronic gaming device 100, via one or more depth image sensing devices, recognizes in order to make inputs for a play of a game. A player may interact with electronic gaming device 100 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 100.

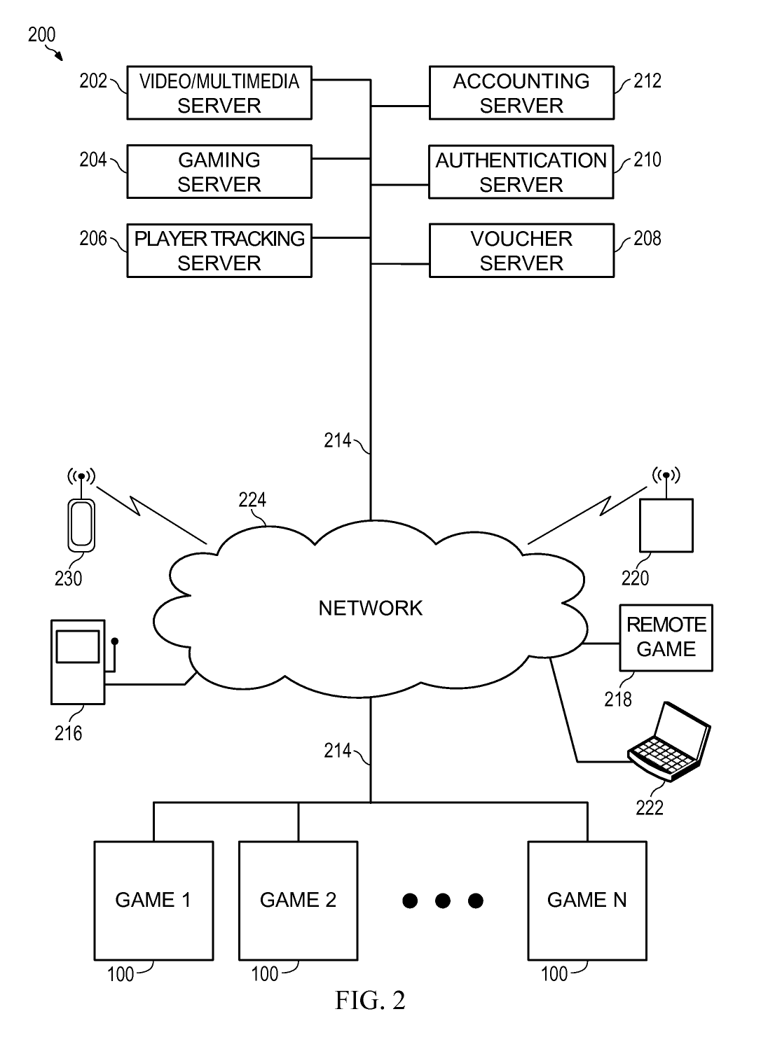

In FIG. 2, an electronic gaming system 200 is shown. Electronic gaming system 200 may include a video/multimedia server 202, a gaming server 204, a player tracking server 206, a voucher server 208, an authentication server 210, and an accounting server 212.

Electronic gaming system 200 may include video/multimedia server 202, which may be coupled to network 224 via a network link 214. Network 224 may be the Internet, a private network, and/or a network cloud. One or more video streams may be received at video/multimedia server 202 from other electronic gaming devices 100. Video/multimedia server 202 may transmit one or more of these video streams to a mobile phone 230, electronic gaming device 100, a remote electronic gaming device at a different location in the same property 216, a remote electronic gaming device at a different location 218, a laptop 222, and/or any other remote electronic device 220. Video/multimedia server 202 may transmit these video streams via network link 214 and/or network 224.

For example, a remote gaming device at the same location may be utilized at a casino with multiple casino floors, a casino that allows wagering activities to take place from the hotel room, a casino that may allow wagering activities to take place from the pool area, etc. In another example, the remote devices may be at another location via a progressive link to another casino, and/or a link within a casino corporation that owns numerous casinos (e.g., MGM, Caesars, etc.).

Gaming server 204 may generate gaming outcomes. Gaming server 204 may provide electronic gaming device 100 with game play content. Gaming server 204 may provide electronic gaming device 100 with game play math and/or outcomes. Gaming server 204 may provide one or more of ambient light functionality, a payout functionality, a game play functionality, a game play evaluation functionality, other game functionality, and/or any other virtual game functionality.

Player tracking server 206 may track a player's betting activity, a player's preferences (e.g., language, font, sound level, drinks, etc.). Based on data obtained by player tracking server 206, a player may be eligible for gaming rewards (e.g., free play), promotions, and/or other awards (e.g., complimentary food, drinks, lodging, concerts, etc.). Player tracking server 206 may be utilized for both the universal player tracking card system and/or one or more casino specific player tracking card systems.

Voucher server 208 may generate a voucher, which may include data relating to gaming. Further, the voucher may include payline structure option selections. In addition, the voucher may include player point data (e.g., balances, etc.), game play data (or similar game play data), reel data, repeat payline data, pattern data, historical payout data, column data, row data, and/or symbols that were modified.

Authentication server 210 may determine the validity of player cards, universal player cards, vouchers, player's identity, and/or an outcome for a gaming event.

Accounting server 212 may compile, track, and/or monitor cash flows, voucher transactions, winning vouchers, losing vouchers, and/or other transaction data. Transaction data may include the number of wagers, the size of these wagers, the date and time for these wagers, the identity of the players making these wagers, and/or the frequency of the wagers. Accounting server 212 may generate tax information relating to these wagers. Accounting server 212 may generate profit/loss reports for players' tracked outcomes. Accounting server 212 may generate one or more expense reports for the universal player tracking system and/or any other report (e.g., player's point balances, player point rankings, frequency of use, etc.).

Network connection 214 may be used for communication between dedicated servers, thin clients, thick clients, back-office accounting systems, etc.

Laptop computer 222 and/or any other electronic devices (e.g., mobile phone 230, electronic gaming device 100, etc.) may be used for downloading new gaming device applications or gaming device related firmware through remote access.

Laptop computer 222 and/or any other electronic device (e.g., mobile phone 230, electronic gaming device 100, etc.) may be used for uploading accounting information (e.g., cashable credits, non-cashable credits, coin in, coin out, bill in, voucher in, voucher out, etc.).

Network 224 may be a local area network, a casino premises network, a wide area network, a virtual private network, an enterprise private network, the Internet, or any combination thereof. Hardware components, such as network interface cards, repeaters and hubs, bridges, switches, routers, firewalls, or any combination thereof may also be part of network 224.

A statistics server may be used to maintain data relating to historical game play for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

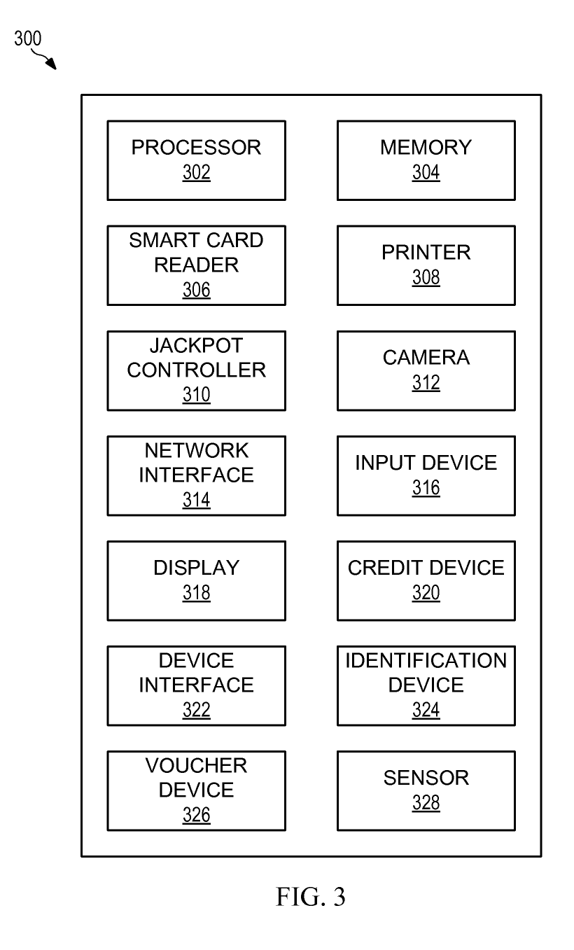

FIG. 3 shows a block diagram 300 of electronic gaming device 100. Electronic gaming device 100 may include a processor 302, a memory 304, a smart card reader 306, a printer 308, a jackpot controller 310, a camera 312, a network interface 314, an input device 316, a display 318, a credit device 320, a device interface 322, an identification device 324, and a voucher device 326.

Processor 302 may execute program instructions of memory 304 and use memory 304 for data storage. Processor 302 may also include a numeric co-processor, or a graphics processing unit (or units) for accelerated video encoding and decoding, and/or any combination thereof.

Processor 302 may include communication interfaces for communicating with electronic gaming device 100, electronic gaming system 200, and user interfaces to enable communication with all gaming elements. For example, processor 302 may interface with memory 304 to access a player's mobile device through device interface 322 to display contents onto display 318. Processor 302 may generate a voucher based on a wager confirmation, which may be received by an input device, a server, a mobile device, and/or any combination thereof. A voucher device may generate, print, transmit, or receive a voucher. Memory 304 may include communication interfaces for communicating with electronic gaming device 100, electronic gaming system 200, and user interfaces to enable communication with all gaming elements. For example, the information stored on memory 304 may be printed out onto a voucher by printer 308. Videos or pictures captured by camera 312 may be saved and stored on memory 304. Memory 304 may include a confirmation module, which may authenticate a value of a voucher and/or the validity of the voucher. Processor 302 may determine the value of the voucher based on generated voucher data and data in the confirmation module. Electronic gaming device 100 may include a player preference input device. The player preference input device may modify a game configuration. The modification may be based on data from the identification device.

Memory 304 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 304 may also be volatile semiconductor memory such as, dynamic random access memory (“DRAM”), static random access memory (“SRAM”), and/or any combination thereof.

Memory 304 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 304 may be used to store read-only program instructions for execution by processor 302, for the read-write storage for global variables and static variables, read-write storage for uninitialized data, read-write storage for dynamically allocated memory, for the read-write storage of the data structure known as “the stack,” and/or any combination thereof.

Memory 304 may be used to store the read-only paytable information for which symbol combinations on a given payline that result in a win (e.g., payout) which are established for games of chance, such as slot games and video poker.

Memory 304 may be used to store accounting information (e.g., cashable electronic promotion in, non-cashable electronic promotion out, coin in, coin out, bill in, voucher in, voucher out, electronic funds transfer in, etc.).

Memory 304 may be used to record error conditions on an electronic gaming device 100, such as door open, coin jam, ticket print failure, ticket (e.g., paper) jam, program error, reel tilt, etc., and/or any combination thereof.

Memory 304 may also be used to record the complete history for the most recent game played, plus some number of prior games as may be determined by the regulating authority.

Smart card reader 306 may allow electronic gaming device 100 to access and read information provided by the player or technician, which may be used for setting the player preferences and/or providing maintenance information. For example, smart card reader 306 may provide an interface between a smart card (inserted by the player) and identification device 324 to verify the identity of a player.

Printer 308 may be used for printing slot machine payout receipts, slot machine wagering vouchers, non-gaming coupons, slot machine coupons (e.g., a wagering instrument with a fixed waging value that can only be used for non-cashable credits), drink tokens, comps, and/or any combination thereof.

Electronic gaming device 100 may include a jackpot controller 310, which may allow electronic gaming device 100 to interface with other electronic gaming devices either directly or through electronic gaming system 200 to accumulate a shared jackpot.

Camera 312 may allow electronic gaming device 100 to take images of a player or a player's surroundings. In one example, this image may be utilized to verify that the player's identity matches to the universal player's tracking card being utilized (e.g., photo on file is compared to image to ensure that the correct person is using the universal player's tracking card). For example, when a player sits down at the machine their picture may be taken to include his or her image into the game play. A picture of a player may be an actual image as taken by camera 312. A picture of a player may be a computerized caricature of the image taken by camera 312. The image obtained by camera 312 may be used in connection with identification device 324 using facial recognition. Camera 312 may allow electronic gaming device 100 to record video. The video may be stored on memory 304 or stored remotely via electronic gaming system 200. Videos obtained by camera 312 may then be used as part of game play, or may be used for security purposes. For example, a camera located on electronic gaming device 100 may capture videos of a potential illegal activity (e.g., tampering with the machine, crime in the vicinity, underage players, etc.).

Network interface 314 may allow electronic gaming device 100 to communicate with video/multimedia server 202, gaming server 204, player tracking server 206, voucher server 208, authentication server 210, and/or accounting server 212.

Input device 316 may be mechanical buttons, electronic buttons, a touch screen, and/or any combination thereof. Input device 316 may be utilized to make a wager, to select one or more game elements, to select one or more gaming options, to make an offer to buy or sell a voucher, to determine a voucher's worth, to cash in a voucher, to modify electronic gaming device 100 (e.g., change sound level, configuration, font, language, etc.), to select a movie or music, to select live video streams (e.g., sporting event 1, sporting event 2, sporting event 3), to request services (e.g., drinks, manager, etc.), and/or any combination thereof.

Display 318 may show video streams from one or more content sources. Display 318 may encompass first display screen 102, second display screen 104, third display screen 106, side display screen 108, and/or another screen used for displaying video content.

Credit device 320 may be utilized to collect monies and distribute monies (e.g., cash, vouchers, etc.). Credit device 320 may interface with processor 302 to allow game play to take place. Processor 302 may determine any payouts, display configurations, animation, and/or any other functions associated with game play. Credit device 320 may interface with display 318 to display the amount of available credits for the player to use for wagering purposes. Credit device 320 may interface via device interface 322 with a mobile device to electronically transmit money and/or credits. Credit device 320 may interface with a player's pre-established account, which may be stored on electronic gaming system 200, to electronically transmit money, player points, and/or credits. For example, a player may have a credit card or other mag-stripe card on file with the location for which money and/or credits can be directly applied when the player is done. Credit device 320 may interface with a player's card to exchange player points.

Electronic gaming device 100 may include a device interface 322 that a user may employ with his or her mobile device (e.g., smart phone) to receive information from and/or transmit information to electronic gaming device 100 (e.g., watch a movie, listen to music, obtain verbal betting options, verify identification, transmit credits, etc.). This information may include QR codes, other codes, and/or any other player data.

Identification device 324 may be utilized to allow electronic gaming device 100 to determine an identity of a player. Based on information obtained by identification device 324, electronic gaming device 100 may be reconfigured. For example, the language, sound level, music, placement of video streams, placement of images, placement of gaming options, and/or the tables utilized may be modified based on player preference data. For example, a player may have selected a specific baseball team (e.g., Atlanta Braves) under the sporting event preferences, the electronic gaming device 100 will then automatically (or via player input) display the current baseball game (e.g., Atlanta Braves vs. Philadelphia Phillies) onto side display screen 108 and/or an alternate display screen as set in the player's options.

A voucher device 326 may generate, print, transmit, or receive a voucher. The voucher may represent a wagering option, a wagering structure, a wagering timeline, a value of wager, a payout potential, a payout, player point data, universal player point data, and/or any other wagering data. A voucher may represent an award, which may be used at other locations inside of the gaming establishment. For example, the voucher may be a coupon for the local buffet or a concert ticket.

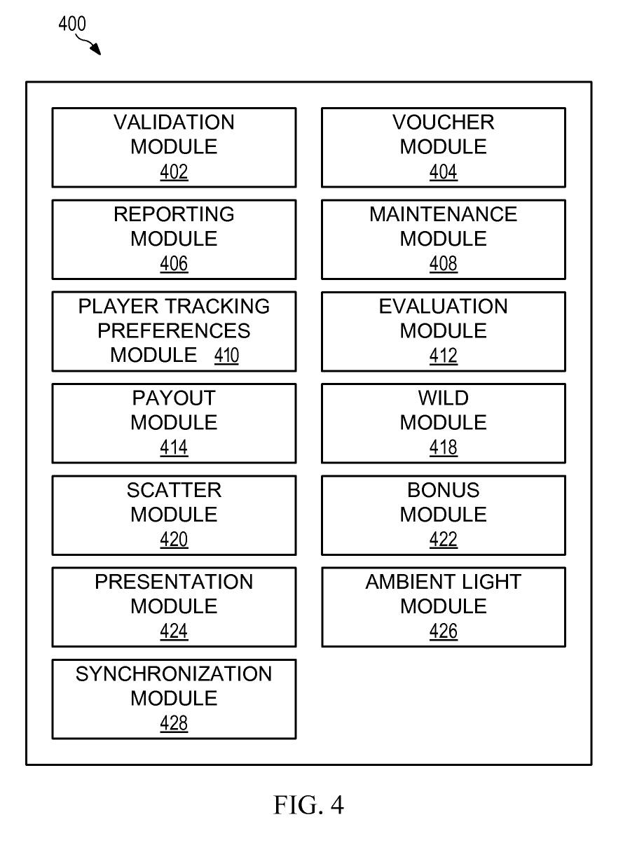

FIG. 4 shows a block diagram of memory 304, which includes various modules. Memory 304 may include a validation module 402, a voucher module 404, a reporting module 406, a maintenance module 408, a player tracking preferences module 410, an evaluation module 412, a payout module 414, a wild module 418, a scatter module 420, a bonus module 422, a presentation module 424, an ambient light module 426, and a synchronization module 428.

Validation module 402 may utilize data received from voucher device 326 to confirm the validity of the voucher.

Voucher module 404 may store data relating to generated vouchers, redeemed vouchers, bought vouchers, and/or sold vouchers.

Reporting module 406 may generate reports related to a performance of electronic gaming device 100, electronic gaming system 200, video streams, gaming objects, credit device 114, and/or identification device 118.

Maintenance module 408 may track any maintenance that is implemented on electronic gaming device 100 and/or electronic gaming system 200. Maintenance module 408 may schedule preventative maintenance and/or request a service call based on a device error.

Player tracking preferences module 410 may compile and track data associated with a player's preferences.

Evaluation module 412 may evaluate one or more outcomes for one or more events relating to game play.

Payout module 414 may determine one or more payouts which may relate to one or more inputs received from the player, electronic gaming device 100, and/or electronic gaming system 200.

Wild module 418 may generate a wild game, evaluate the results of the wild game, trigger wild game presentations, generate wild game payouts, and/or display any data relating to the wild game. Further, wild module 418 may determine one or more outcomes of one or more interactions (e.g., collisions of one or more symbols).

Scatter module 420 may generate a scatter game, evaluate the results of the scatter game, trigger scatter game presentations, generate scatter game payouts, and/or display any data relating to the scatter game.

Bonus module 422 may generate a bonus game, evaluate the results of the bonus game, trigger bonus game presentations, generate bonus game payouts, and/or display any data relating to the bonus game.

Presentation module 424 may generate, initiate, display, store, and compile one or more presentations to be utilized on one or more display screens of the electronic gaming device.

Ambient light module 426 may generate, initiate, display, store, and compile one or more ambient lighting shows to be utilized on the outside of the electronic gaming device.

Synchronization module 428 may match, interrelate, and/or synchronize one or more presentations with each other, one or more ambient lighting shows with each other, one or more presentations with one or more ambient lighting shows, and/or any combination thereof.

A promotional system may generate, compile, store, and/or transmit data relating to one or more promotions for one or more ambient light functionality game playing options.

It should be noted that one or more modules may be combined into one module. Further, there may be one evaluation module where the determined payout does not depend on whether there were any wild symbols, scatter symbols, platform based game play, and/or any other specific symbols. Further, any module, device, and/or logic function in electronic gaming device 100 may be present in electronic gaming system 200. In addition, any module, device, and/or logic function in electronic gaming system 200 may be present in electronic gaming device 100.

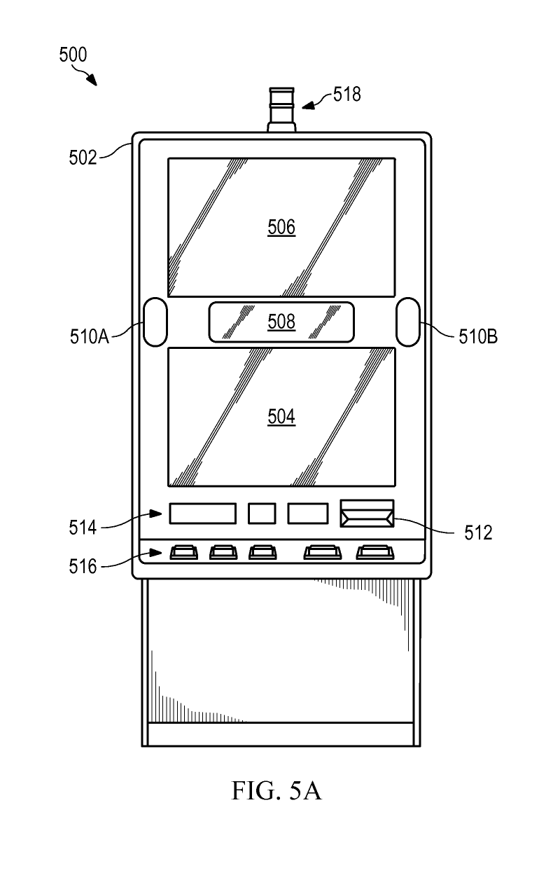

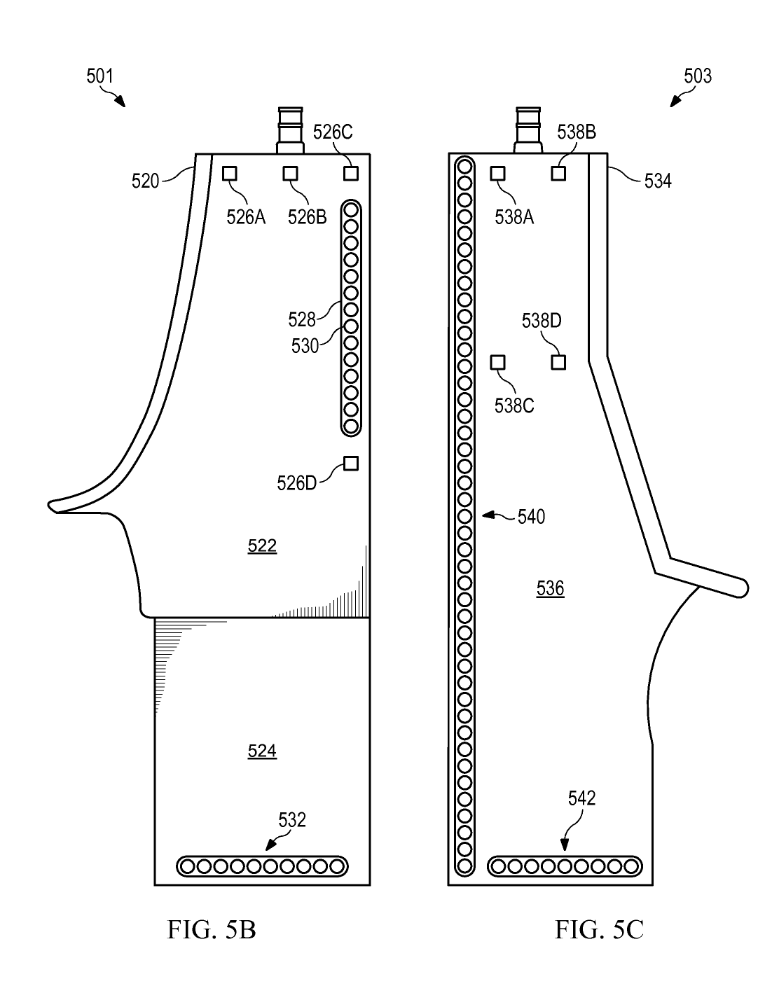

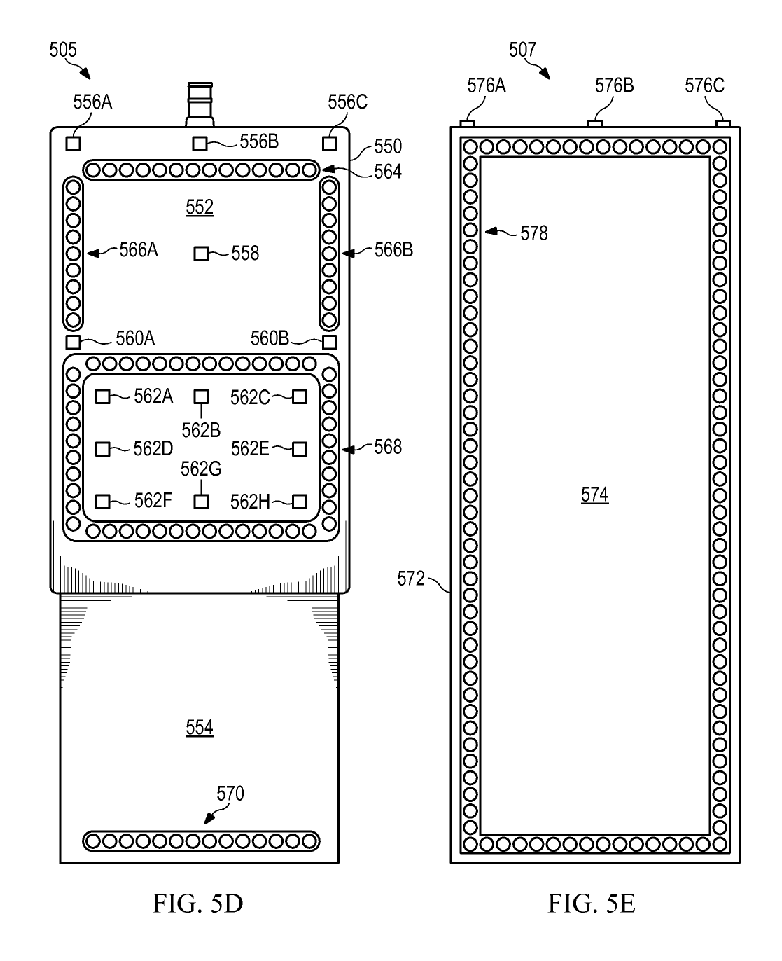

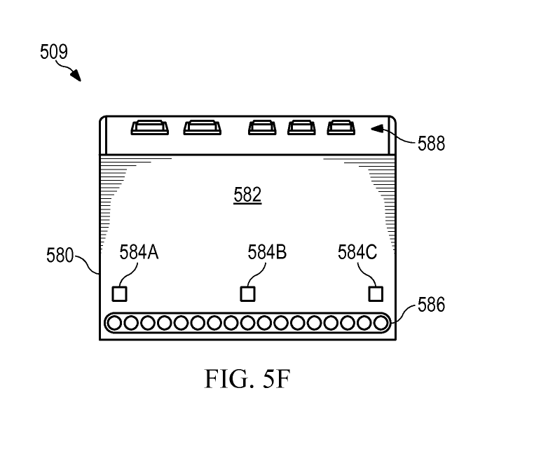

In FIG. 5A, an illustration of a gaming device cabinet 500 is shown, according to one embodiment. A gaming device 502 may include an overhead display 506, a side display 508, a main game display 504, a left speaker 510A, a right speaker 510B, one or more output devices (e.g., a ticket in/ticket out device 512), one or more input devices 516 (e.g., buttons, etc.), and/or one or more signaling devices 518. In one example, overhead display 506 includes a leadership board sponsor and/or a ranking of tournament players. In one example, the XYZ company has sponsored the leadership board and the leadership board states “XYZ LEADER BOARD.” In another example, leadership display may include data relating to one or more tournaments, such as, the time remaining (e.g., 1 HOUR 31 MINUTES REMAINING). In this example, side display 508 may display a current mode of operation. For example, a current mode may be a tournament mode, a normal mode, a practice mode, a team mode, an individual mode, any combination thereof, etc.

In FIG. 5B, a diagram of a gaming machine with one or more ambient lighting functionalities is shown, according to various embodiments. A first image 501 may include a first ambient light sensor 526A (positioned at the top left on one side of EGM), a second ambient light sensor 526B (positioned at the top center on one side of EGM), a third ambient light sensor 526C (positioned at the top right on one side of EGM), a fourth ambient light sensor 526D (positioned at the lower right on one side of EGM), an Nth ambient light sensor (not shown), a first light emitter strip 528 (positioned on a right-side of the cabinet), a second light emitter strip 532 (positioned on the bottom of pedestal), and/or one or more light emitters 530 on the one or more light emitter strips. The one or more ambient light sensors, the one or more light emitter strips, and/or the one or more light emitters may be located on any position on either a cabinet 522 and/or a pedestal 524. The one or more ambient light sensors, the one or more light emitter strips, and/or the one or more light emitters may be flush with a surface, protruding from a surface, concaved with a surface, and/or any combination thereof.

In FIG. 5B, first light emitter strip 528 may be assembled from metal, a plastic body, a rubber body (and/or any other material and/or any combination thereof). Further, a clear plastic and/or glass cover may be utilized to emit light. In another example, light emitter strip may include one or more light emitters 530. In one example, the light emitters may be multi-color LEDs (any/or any other lighting source) containing red, green, and blue elements whose intensity can be mixed to produce any color. These LEDs may have a diffused white lens that blends the colors without any additional diffusers or reflectors. The LEDs may be chosen for their viewing angle (e.g., wide, narrow, and/or any combination thereof). In one example, the length of first light emitter strip 528 may be half the size of cabinet 522 and/or pedestal 524. In various examples, the size and/or orientation of the light emitter strips may be any size, orientation, and/or shape. For example, a light emitter strip may run the entire outer diameter of cabinet 522 and/or pedestal 524 (see FIG. 5E). In another example, there may be any number (e.g., 1-N) of light emitter strips. In addition, the light emitter strip may be half the size of cabinet 522. In addition, the light emitter strip may be the entire size or more of cabinet 522 (see FIG. 5C). In other examples, the light emitter strip's length may be 1%, 2%, 5%, 8%, 10%, 12.5%, 15%, 20%, 25%, 40%, 65%, 75%, 80%, 82%, etc. of cabinet 522 and/or pedestal 524. In various examples, the light emitter strip's orientation may be vertical, horizontal, diagonal, and/or any combination thereof. In various examples, the light emitter strip may be an S shape, a line shape (see FIG. 5B), a T shape, a L shape (see FIG. 5C), an O shape, a P shape, a Z shape, a Y shape, an elliptical shape, etc.

In FIG. 5C, another diagram of a gaming machine with one or more ambient lighting functionalities is shown, according to various embodiments. A second image 503 may include a first ambient light sensor 538A (positioned at the top left on one side and/or both sides of EGM), a second ambient light sensor 538B (positioned at the top right on one side and/or both sides of EGM), a third ambient light sensor 538C (positioned at the left center on one side and/or both sides of EGM), a fourth ambient light sensor 538D (positioned at the right center on one side, both sides, three sides, and/or all sides of EGM), an Nth ambient light sensor (not shown), a first light emitter strip 540, a second light emitter strip 542, and an Nth light emitter strip (not shown).

In FIG. 5D, another diagram of a gaming machine with one or more ambient lighting functionalities is shown, according to various embodiments. A third image 505 may include a first ambient light sensor 556A (located at the top left of the cabinet face 550), a second ambient light sensor 556B (located at the top center of the cabinet face), a third ambient light sensor 556C (located at the top left of the cabinet face), a fourth ambient light sensor 558 (located at the middle center of the cabinet face), and/or an Nth ambient light sensor (not shown) may be located around and/or on a first display area. In addition, a first light emitter strip 566A, a main light emitter strip 564, a second light emitter strip 566B, and/or an Nth light emitter strip may be located around and/or on a first display area. Further, a first center ambient light sensor 560A and a second center ambient light sensor 560B may be located between the first display and a second display. In another example, a circular light emitter strip 568 may surround the second display. In addition, there may be one or more ambient light sensors (e.g., reference numbers 562A, 562B, 562C, 562D, 562E, 562F, 562G, 562H, etc.) located in and/or around second display and/or circular light emitter strip 568.

In FIG. 5E, another diagram of a gaming machine with one or more ambient lighting functionalities is shown, according to various embodiments. A fourth image may include a first ambient light sensor 576A (located on the top and on the right of cabinet), a second ambient light sensor 576B (located on the top and in the middle of cabinet), a third ambient light sensor 576C (located on the top and on the left of cabinet), and/or an Nth ambient light sensor (not shown). In addition, a first light emitter strip 578 may be positioned to encompass the entire outside of cabinet and/or pedestal.

In FIG. 5F, another diagram of a gaming machine with one or more ambient lighting functionalities is shown, according to various embodiments. In this example, a top view of cabinet is shown. In this example, a first ambient light sensor 584A (located on the top and on the left of cabinet), a second ambient light sensor 584B (located on the top and in the middle of cabinet), a third ambient light sensor 584C (located on the top and on the right of cabinet), and/or an Nth ambient light sensor (not shown). In addition, a first light emitter strip 586 may be positioned on the top of cabinet.

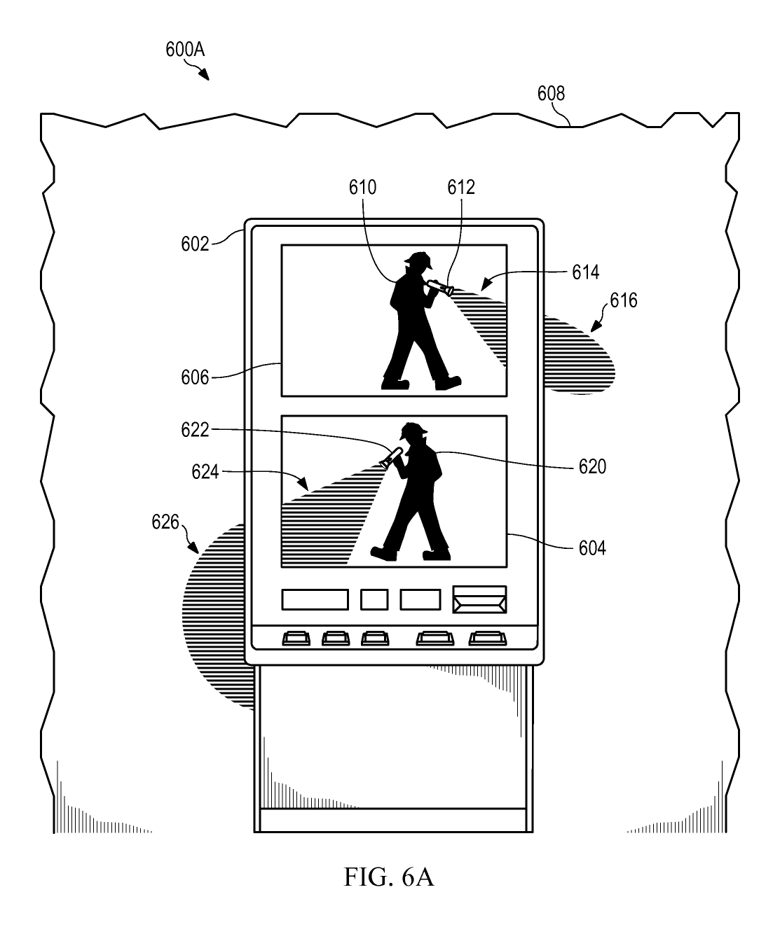

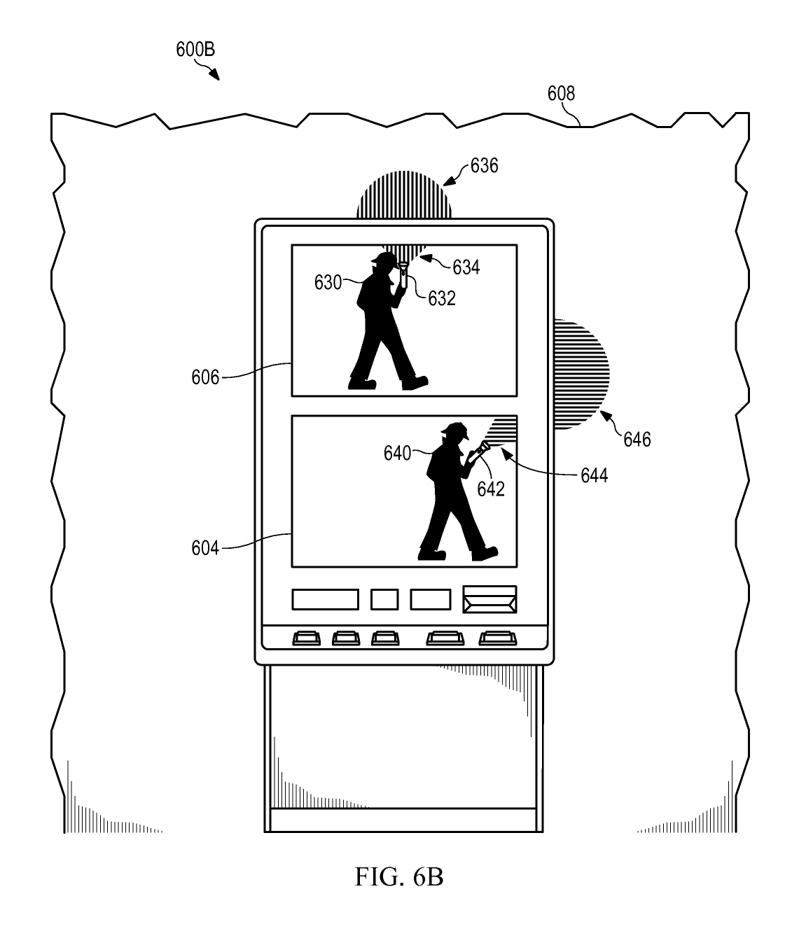

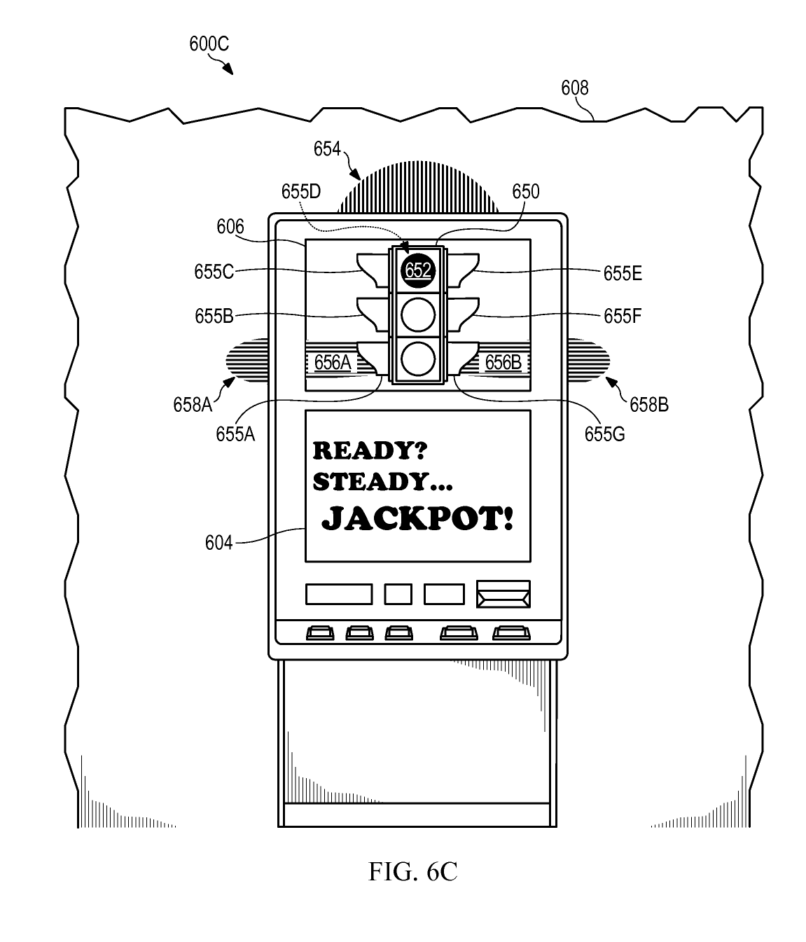

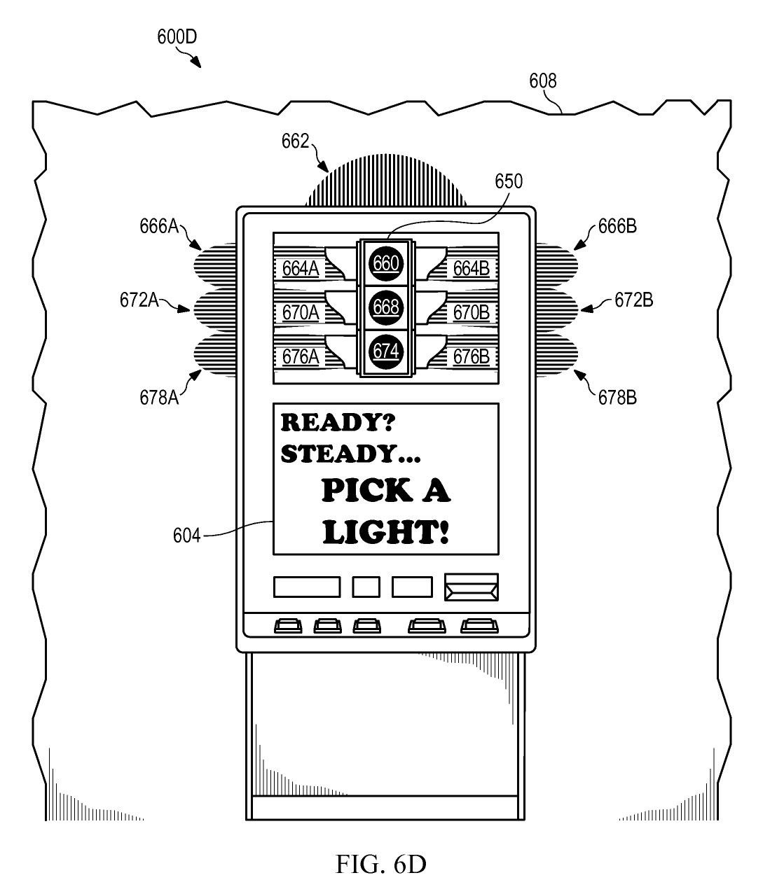

In FIG. 6A, a diagram illustrating various ambient lighting functionalities is shown, according to various embodiments. A fifth image 600A includes an electronic gaming device 602 with a first display screen 604 and a second display screen 606. In one example, a first character 610 (and/or any other image) may have a first tool 612 (and/or any other item). In one example, first tool 612 may emit (and/or be illustrated to emit and/or animated to emit, etc.) a first display area 614. In this example, first display area 614 may be located within second display screen 606 and/or anywhere on electronic gaming device 602. In this example, a first ambient lit area 616 (via one or more ambient light sensors and/or one or more light emitters—see FIGS. 5A-5F) may be synchronized, related to, matched to, correlated to, interrelated to, and/or any combination thereof with first display area 614. In this example, first ambient lit area 616 appears on the right side of electronic gaming device 602. In this example, as first display area 614 moves first ambient lit area 616 moves with first display area 614. Based on this movement, first display area 614 and first ambient lit area 616 move with each other and may appear to be one consistent area. In addition, when first display area 614 and first ambient lit area 616 move with each other, ambient light may appear to move in sync with the first display area 614. The ambient light may be in any location (e.g., the front of the electronic gaming machine, the back of the electronic gaming machine, the left side of the electronic gaming machine, the right side of the electronic gaming machine, the top of the electronic gaming machine, a back wall, a side wall, and/or any other location near and/or on the electronic machine, and/or any other location in the casino, and/or any combination thereof).

In another example, a second character 620 (and/or any other image) may have a second tool 622 (and/or any other item). In this example, second tool 622 may emit (and/or be illustrated to emit and/or animated to emit, etc.) a second display area 624. In this example, second display area 624 may be located within first display screen 604 and/or anywhere on electronic gaming device 602. In this example, a second ambient lit area 626 (via one or more ambient light sensors and/or one or more light emitters—see FIGS. 5A-5F) may be synchronized, related to, matched to, correlated to, interrelated to, and/or any combination thereof with second display area 624. In this example, second ambient lit area 626 appears on the left side of electronic gaming device 602. In this example, as second display area 624 moves second ambient lit area 626 moves with second display area 624. Based on this movement, second display area 624 and second ambient lit area 626 move with each other and may appear to be one consistent area. In addition, when second display area 624 and second ambient lit area 626 move with each other, ambient light may appear to move in sync with the second display area 624.

In FIG. 6B, another diagram illustrating various ambient lighting functionalities is shown, according to various embodiments. A sixth image 600B includes electronic gaming device 602 with first display screen 604 and second display screen 606. In one example, a third character 630 (and/or any other image) may have third tool 632 (and/or any other item). In one example, third tool 632 may emit (and/or be illustrated to emit and/or animated to emit, etc.) a third display area 634. In this example, third display area 634 may be located within second display screen 606 and/or anywhere on electronic gaming device 602. In this example, a third ambient lit area 636 (via one or more ambient light sensors and/or one or more light emitters—see FIGS. 5A-5F) may be synchronized, related to, matched to, correlated to, interrelated to, and/or any combination thereof with third display area 634. In this example, third ambient lit area 636 appears on the top of electronic gaming device 602. In this example, as third display area 634 moves third ambient lit area 636 moves with third display area 634. Based on this movement, third display area 634 and third ambient lit area 636 move with each other and may appear to be one consistent area. In addition, when third display area 634 and third ambient lit area 636 move with each other, ambient light may appear to move in sync with the third display area 634. The ambient light may be in any location (e.g., the front of the electronic gaming machine, the back of the electronic gaming machine, the left side of the electronic gaming machine, the right side of the electronic gaming machine, the top of the electronic gaming machine, a back wall, a side wall, and/or any other location near and/or on the electronic machine, and/or any other location in the casino, and/or any combination thereof).

In another example, a fourth character 640 (and/or any other image) may have a fourth tool 642 (and/or any other item). In this example, fourth tool 642 may emit (and/or be illustrated to emit and/or animated to emit, etc.) a fourth display area 644. In this example, fourth display area 644 may be located within first display screen 604 and/or anywhere on electronic gaming device 602. In this example, a fourth ambient lit area 646 (via one or more ambient light sensors and/or one or more light emitters—see FIGS. 5A-5F) may be synchronized, related to, matched to, correlated to, interrelated to, and/or any combination thereof with fourth display area 644. In this example, fourth ambient lit area 646 appears on the right side of electronic gaming device 602. In this example, as fourth display area 644 moves fourth ambient lit area 646 moves with fourth display area 644. Based on this movement, fourth display area 644 and fourth ambient lit area 646 move with each other and may appear to be one consistent area. In addition, when fourth display area 644 and fourth ambient lit area 646 move with each other, ambient light may appear to move in sync with the fourth display area 644.

In FIG. 6C, another diagram illustrating various ambient lighting functionalities is shown, according to various embodiments. A seventh image 600C includes electronic gaming device 602 with first display screen 604 and second display screen 606. In one example, a fifth item 650 (and/or any other image and/or any other character) may have one or more image (e.g., light, etc.) generating sites. In this example, fifth item 650 may have a first image source 655A, a second image source 655B, a third image source 655C, a fourth image source 655D, a fifth image source 655E, a sixth image source 655F, a seventh image source 655G, an eighth image source 652, and/or an Nth image source (not shown).

In one example, fifth item 650 may emit (and/or be illustrated to emit and/or animated to emit, etc.) a first display area 656A, a second display area 656B, and/or an Nth display area. In this example, first display area 656A (via first image source 655A), second display area 656B (via seventh image source 655G), and/or an Nth display area may be located within second display screen 606 and/or anywhere on electronic gaming device 602.

In this example, a first ambient lit area 658A, a second ambient lit area 658B, a third ambient lit area 654, and/or an Nth ambient lit area (via one or more ambient light sensors and/or one or more light emitters—see FIGS. 5A-5F) may be synchronized, related to, matched to, correlated to, interrelated to, and/or any combination thereof with one or more of first display area 656A, second display area 656B, and/or an Nth display area. In various example, first ambient lit area 658A, second ambient lit area 658B, third ambient lit area 654, and/or an Nth ambient lit area may be in any location (e.g., the front of the electronic gaming machine, the back of the electronic gaming machine, the left side of the electronic gaming machine, the right side of the electronic gaming machine, the top of the electronic gaming machine, a back wall, a side wall, and/or any other location near and/or on the electronic machine, and/or any other location in the casino, and/or any combination thereof). In this example, first ambient lit area 658A was located to the left of electronic gaming device 602, second ambient lit area 658B was located to the right of electronic gaming device 602, and third ambient lit area 654 was located on the top (and/or back) of electronic gaming device 602.

In this example, as first display area 656A, second display area 656B, and/or Nth display area move first ambient lit area 658A, second ambient lit area 658B, third ambient lit area 654, and/or Nth ambient lit area moves with one or more of first display area 656A, second display area 656B, and/or Nth display area. Based on this movement, first display area 656A, second display area 656B, Nth display area, first ambient lit area 658A, second ambient lit area 658B, third ambient lit area 654, and/or Nth ambient lit area move with each other and may appear to be one or more consistent areas. In addition, when first display area 656A, second display area 656B, Nth display area, first ambient lit area 658A, second ambient lit area 658B, third ambient lit area 654, and/or Nth ambient lit area move with each other, ambient light, any image, and/or any other images may appear to move in sync.

In one example, first display screen 604 may state one or more messages including “READY? STEADY . . . JACKPOT!”

In FIG. 6D, another diagram illustrating various ambient lighting functionalities is shown, according to various embodiments. An eighth image 600D includes electronic gaming device 602 with first display screen 604 and second display screen 606. In one example, fifth item 650 (and/or any other image and/or any other character) may have one or more image (e.g., light, etc.) generating sites. In this example, fifth item 650 may have first image source 655A, second image source 655B, third image source 655C, fourth image source 655D, fifth image source 655E, sixth image source 655F, seventh image source 655G, eighth image source 652, a ninth image source 660, a tenth image source 668, an eleventh image source 674, and/or an Nth image source (not shown).

In one example, fifth item 650 may emit (and/or be illustrated to emit and/or animated to emit, etc.) a first display area 664A, a second display area 664B, a third display area 670A, a fourth display area 670B, a fifth display area 676A, a sixth display area 676B, and/or an Nth display area. In this example, first display area 664A, second display area 664B, third display area 670A, fourth display area 670B, fifth display area 676A, sixth display area 676B, and/or an Nth display area may be located within second display screen 606 and/or anywhere on electronic gaming device 602.

In this example, a first ambient lit area 666A, a second ambient lit area 642A, a third ambient lit area 678A, a fourth ambient lit area 666B, a fifth ambient lit area 672B, a sixth ambient lit area 678B, a seventh ambient lit area 662 and/or an Nth ambient lit area (via one or more ambient light sensors and/or one or more light emitters—see FIGS. 5A-5F) may be synchronized, related to, matched to, correlated to, interrelated to, and/or any combination thereof with one or more of first display area 664A, second display area 664B, third display area 670A, fourth display area 670B, fifth display area 676A, sixth display area 676B, and/or an Nth display. In various example, first ambient lit area 666A, second ambient lit area 672A, third ambient lit area 678A, fourth ambient lit area 666B, fifth ambient lit area 672B, sixth ambient lit area 678B, seventh ambient lit area 662 and/or an Nth ambient lit area may be in any location (e.g., the front of the electronic gaming machine, the back of the electronic gaming machine, the left side of the electronic gaming machine, the right side of the electronic gaming machine, the top of the electronic gaming machine, a back wall, a side wall, and/or any other location near and/or on the electronic machine, and/or any other location in the casino, and/or any combination thereof). In this example, first ambient lit area 666A was located at the top left of electronic gaming device 602 and/or second display screen 606. Second ambient lit area 672A was located at the middle left of electronic gaming device 602 and/or second display screen 606. Third ambient lit area 678A was located at the bottom left of electronic gaming device 602 and/or second display screen 606. Fourth ambient lit area 666B was located at the top right of electronic gaming device 602 and/or second display screen 606. Fifth ambient lit area 672B was located at the middle right of electronic gaming device 602 and/or second display screen 606. Sixth ambient lit area 678B was located at the bottom right of electronic gaming device 602 and/or second display screen 606. Seventh ambient lit area 662 was located on the top (and/or back) of electronic gaming device 602 and/or second display screen 606.

In this example, as first display area 664A, second display area 664B, third display area 670A, fourth display area 670B, fifth display area 676A, sixth display area 676B, and/or an Nth display move first ambient lit area 666A, second ambient lit area 672A, third ambient lit area 678A, fourth ambient lit area 666B, fifth ambient lit area 672B, sixth ambient lit area 678B, seventh ambient lit area 662 and/or an Nth ambient lit area moves with one or more of first display area 664A, second display area 664B, third display area 670A, fourth display area 670B, fifth display area 676A, sixth display area 676B, and/or an Nth display. Based on this movement, first display area 664A, second display area 664B, third display area 670A, fourth display area 670B, fifth display area 676A, sixth display area 676B, Nth display, first ambient lit area 666A, second ambient lit area 672A, third ambient lit area 678A, fourth ambient lit area 666B, fifth ambient lit area 672B, sixth ambient lit area 678B, seventh ambient lit area 662 and/or Nth ambient lit area move with each other and may appear to be one or more consistent areas. In addition, when first display area 664A, second display area 664B, third display area 670A, fourth display area 670B, fifth display area 676A, sixth display area 676B, Nth display, first ambient lit area 666A, second ambient lit area 672A, third ambient lit area 678A, fourth ambient lit area 666B, fifth ambient lit area 672B, sixth ambient lit area 678B, seventh ambient lit area 662 and/or Nth ambient lit area move with each other, ambient light, any image, and/or any other images may appear to move in sync.

In one example, first display screen 604 may state one or more messages including “READY? STEADY . . . PICK A LIGHT!”

In one example, one or more light emitter elements may have to be angled to replicate one or more light shows. Further, one or more light emitter elements may be semi-circles. The lighting elements may vary their intensity and/or one or more light emitting points may be perpendicular to the cabinet surface. In another example, one or more lighting elements from one or more electronic gaming devices may interact to form one or more lighting shows. Further, one or more lighting elements on the electronic gaming device may interact to form one or more lighting shows. The lighting elements may be convex and/or concave shaped. In another example, a light (color) temperature compensation may be utilized to account for the differences in color temperature between (a) the LCD display, (b) a light bar (e.g., a diffused white protective cover), (c) the LED light emitters, and/or (d) any other light source.

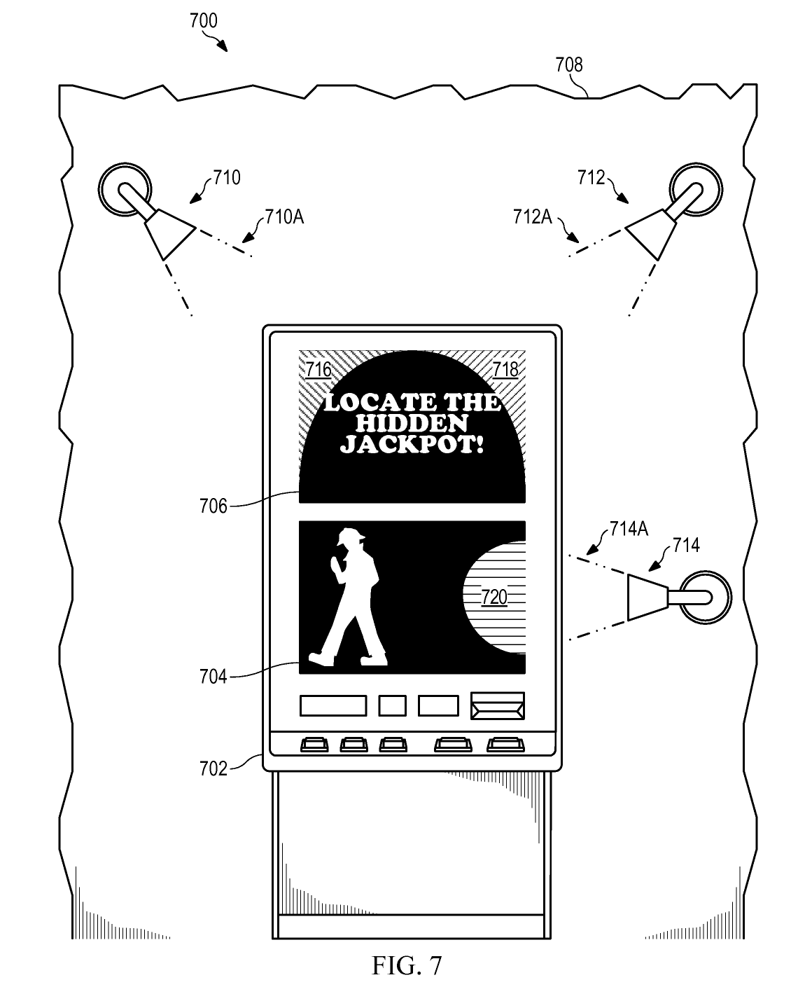

In FIG. 7, another diagram illustrating various ambient lighting functionalities is shown, according to various embodiments. A ninth image 700 includes a first external light source 710, a second external light source 712, and a third external light source 714. In this example, first external light source 710 produces a first light 710A which is utilized to simulate light on second display area 606. This simulated light is shown as first display light area 716. In this example, second external light source 712 produces a second light 712A which is utilized to simulate light on second display area 606. This simulated light is shown as second display light area 718. In this example, third external light source 714 produces a third light 714A which is utilized to simulate light on second display area 606. This simulated light is shown as third display light area 720. In these examples, first external light source 710, second external light source 712, and/or third external light source 714 are external to, not attached to, and/or not physically coupled to electronic gaming device 606.

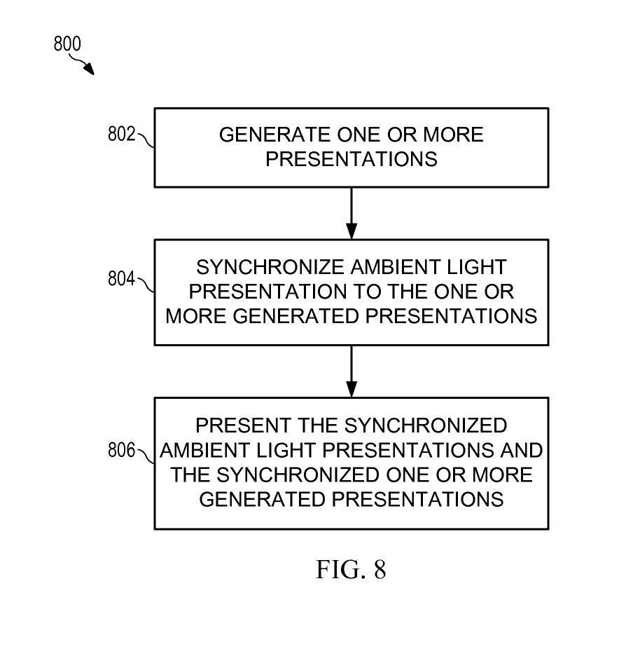

In FIG. 8, a flow diagram for game play 800 is shown, according to one embodiment. The method may include generating one or more presentations (step 802). The method may include synchronizing one or more ambient light presentation to the one or more generated presentations (step 804). The method may include presenting the synchronized one or more ambient light presentations and the synchronized one or more generated presentations (step 806). In one example, a flash light presentation may be presented on one or more displays on electronic gaming machine while one or more ambient light shows which are based on the flash light presentation may be generated by one or more light emitters and one or more light sensors. In this example, the one or more ambient light shows may be synchronized with the flash light presentation so that the one or more ambient light shows appear to be an extension of the flash light presentation.

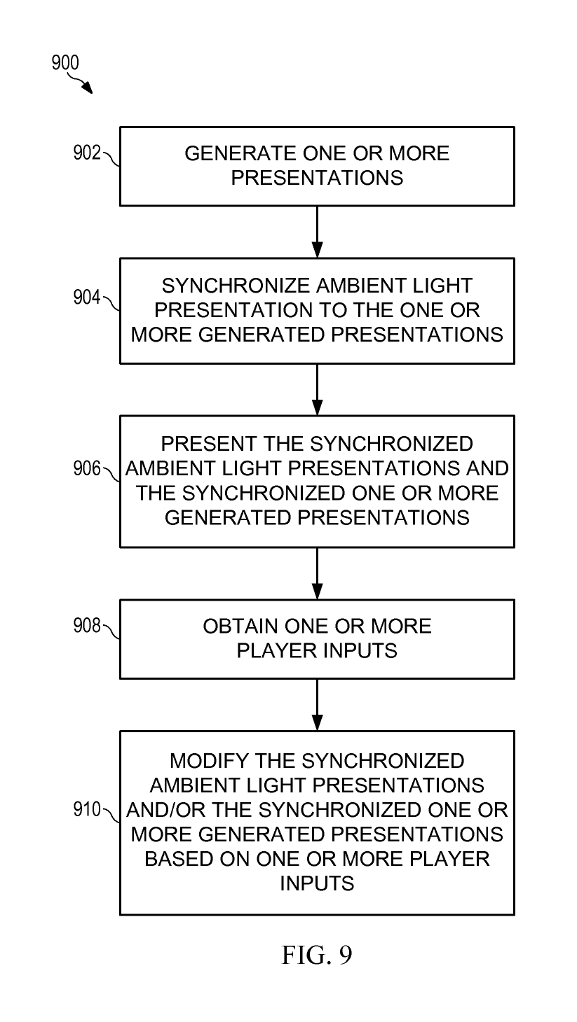

In FIG. 9, another flow diagram for game play 900 is shown, according to one embodiment. The method may include generating one or more presentations (step 902). The method may include synchronizing one or more ambient light presentations to the one or more generated presentations (step 904). The method may include presenting the one or more synchronized ambient light presentations and the synchronized one or more generated presentations (step 906). The method may include obtaining one or more player inputs (step 908). The method may include modifying the one or more synchronized ambient light presentations and/or the synchronized one or more generated presentations based on one or more player inputs (step 910). In one example, a flash light presentation may be presented on one or more displays on electronic gaming machine while one or more ambient light shows which are based on the flash light presentation may be generated by one or more light emitters and one or more light sensors. In this example, the one or more ambient light shows may be synchronized with the flash light presentation so that the one or more ambient light shows appear to be an extension of the flash light presentation. Further, a player may provide input on where the flash light should be pointed to (e.g., trying to find a treasure chest, etc.). Therefore, the flash light presentation would be modified based on this player input along with the one or more ambient light shows. It should be noted that the flash light presentation and the one or more ambient light shows could still be synchronized together after one or more player inputs.

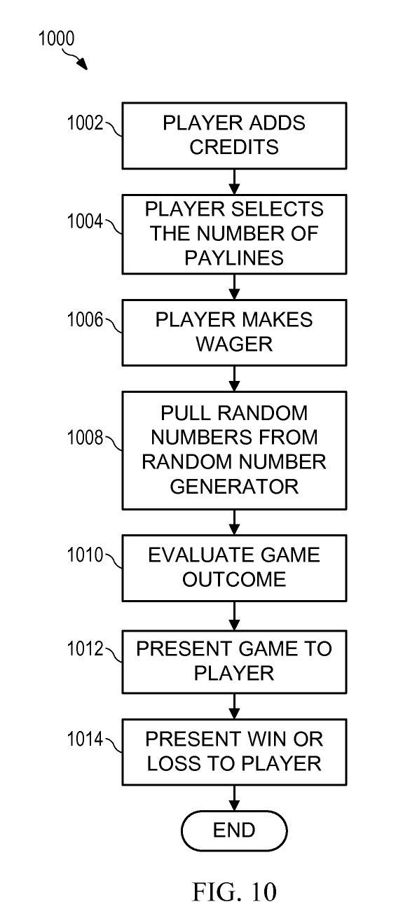

FIG. 10 is a process flowchart of one example of a primary game play 1000 on an electronic gaming system, according to one embodiment. The method may include the step of a player adding credit to the electronic gaming system (step 1002). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1004, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1006, the player makes a wager on the game. In one embodiment, the wager may be a multiple of the number of paylines selected at step 1004. In another embodiment, the wager may not be a multiple of the number of paylines selected at step 1004. In a further embodiment, the wager may include a side-wager (e.g., ante bet), which may, in one example of such an embodiment, be used to make the player eligible to be awarded the extra functionality discussed above. It should be appreciated that in some embodiments, the order of steps 1004 and 1006 may be not critical, and so for example, a player can select the wager they wish to place, and then select the number of paylines they want it applied to, and that these embodiments are expressly contemplated as being within the scope of the present disclosure.

Continuing to step 1008, the gaming system pulls random numbers from a random number generator (“RNG”). In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At steps 1010 and 1012, the gaming system utilizes the random numbers pulled at step 1008 to determine the primary game symbols to display in the play of the primary game, which in turn both determines the presentation of the game to the player and evaluates the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1014, the win or loss outcome may be identified for the player. In one embodiment, this step can include additional messaging, which provides information related to the win or loss, such as why the player won or lost. In another embodiment, this step can include identification of the amount of any award earned by the player.

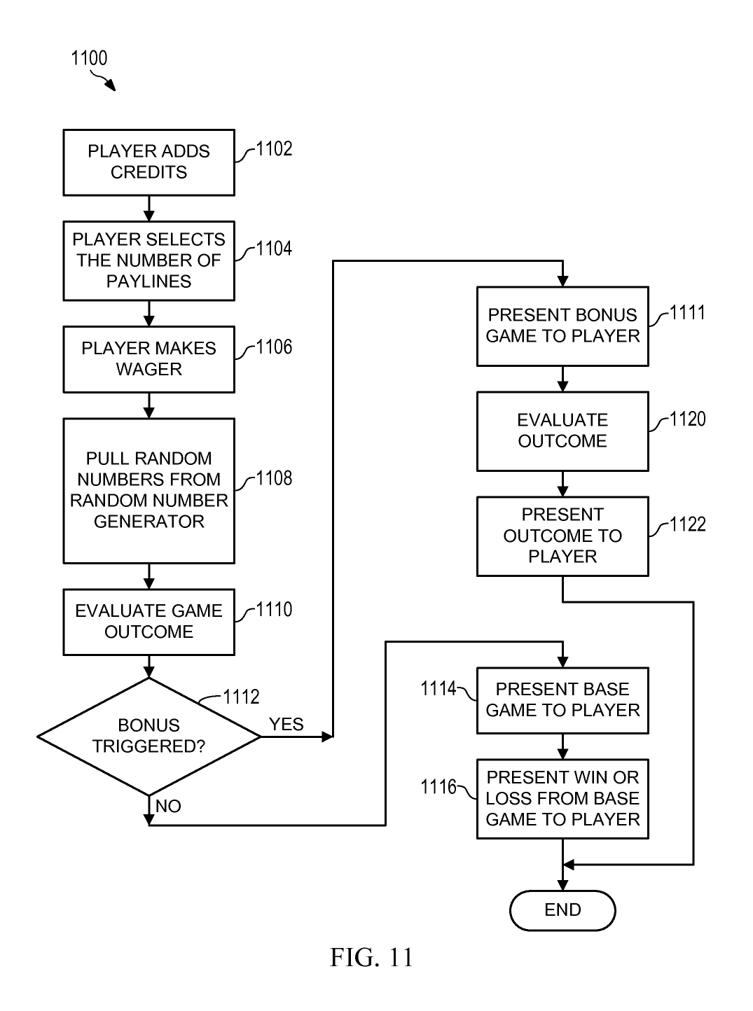

FIG. 11 is a process flowchart of one example of a combined primary and secondary game play 1100 on an electronic gaming system, according to one embodiment. The method may include the step of a player adding credit to the electronic gaming system (step 1102). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1104, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1106, the player makes a wager on the game. In one embodiment, the wager may be a multiple of the number of paylines selected at step 1104. In another embodiment, the wager may not be a multiple of the number of paylines selected at step 1104. In a further embodiment, the wager may include a side-wager, which may, in one example of such an embodiment, be used to make the player eligible to be awarded the extra functionality discussed above. It should be appreciated that in some embodiments, the order of steps 1104 and 1106 may be not critical, and so for example, a player can select the wager they wish to place, and then select the number of paylines they want it applied to, and that these embodiments may be expressly contemplated as being within the scope of the present disclosure.

Continuing to step 1108, the gaming system pulls random numbers from a random number generator “RNG”. In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At step 1110, the gaming system utilizes the random numbers pulled at step 1108 to evaluate the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1112, the gaming system determines if a secondary or bonus game may be triggered. In one embodiment, the bonus game is triggered by the display of a plurality of matching symbols at a plurality of predetermined symbol positions within a play of the primary game. In one example, the bonus game may be triggered if a plurality of matching symbols is displayed on the 2^{nd}, 3^{rd} and 4^{th} reel. In another example, the bonus game may be triggered if matching symbols are displayed on the 1^{st}, 2^{nd} and 3^{rd} reels. In a further example, the bonus game may be triggered if matching symbols occur at predetermined symbol positions that include consecutive and non-consecutive reels. In another example, a bonus game (e.g., secondary game) may be triggered in any way (e.g., one special symbols in any locations, one special symbol in one or more predetermined locations, two special symbols in any locations, two special symbols in one or more predetermined locations, three special symbols in any locations, three special symbols in one or more predetermined locations, etc.).

If it is determined that a bonus or secondary game was not triggered, the process continues to step 1114, where the base game may be fully presented to the player. As discussed above, the orders of step 1110, 1112, and 1114 can be changed without affecting the novel concepts disclosed herein.

At step 1116, the win or loss outcome of the primary game may be identified for the player. In one embodiment, this step can include additional messaging, which provides information related to the win or loss, such as why the player won or lost. In another embodiment, this step can include identification of the amount of any award earned by the player

If it is determined at step 1112 that a bonus or secondary game was triggered, then process 1100 continues to step 1118, where the secondary game may be presented to the player. As discussed above, there are numerous ways to present the secondary or bonus game to the player.

At steps 1120 and 1122, the outcome of the secondary game may be evaluated and presented to the player. In one embodiment, the outcome of the bonus game will always be a winning outcome. In another embodiment, the outcome of the secondary game will cause a significant award to be provided to the player. In one example of such an embodiment, the award may not be provided by the gaming system, as a casino operator may need to verify tax information before allowing such an award to be provided to the player. In one embodiment, instead of the process 1100 ending after step 1122, the process continues to step 1114 so as to finalize the primary game outcome presentation to the player.

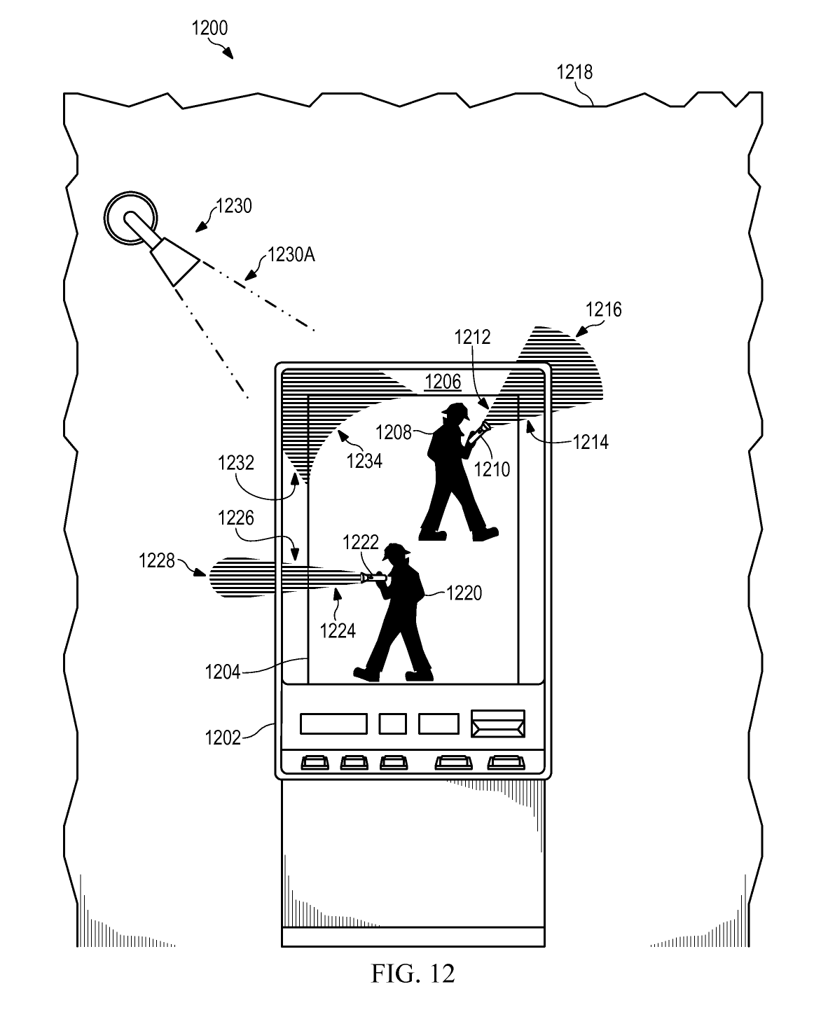

In FIG. 12, another diagram illustrating various ambient lighting functionalities is shown, according to various embodiments. A first illustration 1218 includes an external light source 1230 (e.g., external to the electronic gaming device, etc.), a first image 1208, and a second image 1220. In one example, external light source 1230 creates via one or more modules inside of electronic gaming device (and/or via one or more sensors) a first presentation area 1234 on electronic gaming device (and/or one or more display screens). In another example, first image 1208 has a first tool 1210 which creates a second presentation area 1214 on electronic gaming device (and/or one or more display screens) and a first ambient light show 1216 external the electronic gaming device (and/or one or more display screens). In addition, second image 1220 has a second tool 1222 which creates a third presentation area 1224 on electronic gaming device (and/or one or more display screens) and a second ambient light show 1228 external the electronic gaming device (and/or one or more display screens).

In one embodiment, the electronic gaming device may include a plurality of reels. The plurality of reels includes one or more areas. The electronic gaming device may include a memory and one or more processors. The memory may include one or more ambient lighting modules, one or more presentation modules, and/or one or more synchronization modules. The electronic gaming device may include one or more ambient light sensors and/or one or more light emitters. The one or more processors may display one or more presentations and/or initiate one or more ambient light shows.

In another example, the one or more processors may interrelate the one or more ambient light shows to the one or more presentations. In addition, the one or more processors may synchronize the one or more ambient light shows to the one or more presentations via the one or more synchronization modules. Further, the one or more processors may interrelate at least two of the one or more ambient light shows, the one or more presentations, and an external ambient light show to each other. In another example, the external ambient light show may be generated from and/or by one or more external devices. In one example, the one or more external devices are external to the electronic gaming device. In another example, the one or more external devices are not physically attached to the electronic gaming device. In one example, the one or more processors may synchronize at least two of the one or more ambient light shows, the one or more presentations, and an external ambient light show to each other. In another example, the one or more ambient light sensors may be located on a front-side of the electronic gaming device, a left-side of the electronic gaming device, a right-side of the electronic gaming device, a back-side of the electronic gaming device, a top of the electronic gaming device, any location on the electronic gaming device, any location in proximity to the electronic gaming device, any location external to the electronic gaming device, and/or any combination thereof. In another example, the one or more light emitters may be located on a front-side of the electronic gaming device, a left-side of the electronic gaming device, a right-side of the electronic gaming device, a back-side of the electronic gaming device, a top of the electronic gaming device, any location on the electronic gaming device, any location in proximity to the electronic gaming device, any location external to the electronic gaming device, and/or any combination thereof. Further, the one or more ambient light sensors may be located on a front-side of the electronic gaming device, a left-side of the electronic gaming device, a right-side of the electronic gaming device, a back-side of the electronic gaming device, a top of the electronic gaming device, any location on the electronic gaming device, any location in proximity to the electronic gaming device, any location external to the electronic gaming device, and/or any combination thereof while the one or more light emitters may be located on a front-side of the electronic gaming device, a left-side of the electronic gaming device, a right-side of the electronic gaming device, a back-side of the electronic gaming device, a top of the electronic gaming device, any location on the electronic gaming device, any location in proximity to the electronic gaming device, any location external to the electronic gaming device, and/or any combination thereof.

In another embodiment, the method of providing game play via an electronic gaming device may include: generating one or more presentations on the electronic gaming device and/or generating one or more ambient light shows.

In another example, the method may include interrelating the one or more ambient light shows to the one or more presentations; synchronizing the one or more ambient light shows to the one or more presentations; and/or interrelating at least two of the one or more ambient light shows, the one or more presentations, and an external ambient light show to each other.

In another example, the external ambient light show may be generated from one or more external devices.

In another embodiment, the electronic gaming system may include a server which may include a server processor and a server memory. Further, the electronic gaming system may include a display device which may include a plurality of reels. The plurality of reels may include one or more areas. The server memory may include one or more ambient lighting modules, one or more presentation modules, and/or one or more synchronization modules. The electronic gaming system may include one or more ambient light sensors and/or one or more light emitters. The server processor may display one or more presentations and to initiate one or more ambient light shows.

In another example, the server processor may interrelate the one or more ambient light shows to the one or more presentations and/or synchronize the one or more ambient light shows to the one or more presentations.

Gaming system may be a “state-based” system. A state-based system stores and maintains the system's current state in a non-volatile memory. Therefore, if a power failure or other malfunction occurs, the gaming system will return to the gaming system's state before the power failure or other malfunction occurred when the gaming system may be powered up.

State-based gaming systems may have various functions (e.g., wagering, payline selections, reel selections, game play, bonus game play, evaluation of game play, game play result, steps of graphical representations, etc.) of the game. Each function may define a state. Further, the gaming system may store game histories, which may be utilized to reconstruct previous game plays.

A state-based system may be different than a Personal Computer (“PC”) because a PC is not a state-based machine. A state-based system has different software and hardware design requirements as compared to a PC system.

The gaming system may include random number generators, authentication procedures, authentication keys, and operating system kernels. These devices, modules, software, and/or procedures may allow a gaming authority to track, verify, supervise, and manage the gaming system's codes and data.

A gaming system may include state-based software architecture, state-based supporting hardware, watchdog timers, voltage monitoring systems, trust memory, gaming system designed communication interfaces, and security monitoring.

For regulatory purposes, the gaming system may be designed to prevent the gaming system's owner from misusing (e.g., cheating) via the gaming system. The gaming system may be designed to be static and monolithic.

In one example, the instructions coded in the gaming system are non-changeable (e.g., static) and are approved by a gaming authority and installation of the codes are supervised by the gaming authority. Any change in the system may require approval from the gaming authority. Further, a gaming system may have a procedure/device to validate the code and prevent the code from being utilized if the code is invalid. The hardware and software configurations are designed to comply with the gaming authorities' requirements.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples.

1. An electronic gaming device comprising:
a plurality of reels, the plurality of reels including one or more areas;
a memory, the memory including one or more ambient lighting modules, one or more presentation modules, and one or more synchronization modules;
one or more ambient light sensors;
one or more light emitters; and
one or more processors configured to display one or more presentations and to initiate one or more ambient light shows.

2. The electronic gaming device of claim 1, wherein the one or more processors are further configured to interrelate the one or more ambient light shows to the one or more presentations.

3. The electronic gaming device of claim 1, wherein the one or more processors are further configured to synchronize the one or more ambient light shows to the one or more presentations via the one or more synchronization modules.

4. The electronic gaming device of claim 1, wherein the one or more processors are further configured to interrelate at least two of the one or more ambient light shows, the one or more presentations, and an external ambient light show to each other.

5. The electronic gaming device of claim 4, wherein the external ambient light show is generated from one or more external devices.

6. The electronic gaming device of claim 5, wherein the one or more external devices are external to the electronic gaming device.

7. The electronic gaming device of claim 1, wherein the one or more processors are further configured to synchronize at least two of the one or more ambient light shows, the one or more presentations, and an external ambient light show to each other.

8. The electronic gaming device of claim 7, wherein the external ambient light show is generated from one or more external devices.

9. The electronic gaming device of claim 8, wherein the one or more external devices are external to the electronic gaming device.

10. The electronic gaming device of claim 1, wherein the one or more ambient light sensors are located at least on one of a front-side of the electronic gaming device, a left-side of the electronic gaming device, a right-side of the electronic gaming device, a back-side of the electronic gaming device, and a top of the electronic gaming device.

11. The electronic gaming device of claim 1, wherein the one or more light emitters are located at least on one of a front-side of the electronic gaming device, a left-side of the electronic gaming device, a right-side of the electronic gaming device, a back-side of the electronic gaming device, and a top of the electronic gaming device.

12. The electronic gaming device of claim 1, wherein the one or more ambient light sensors are located at least on one of a front-side of the electronic gaming device, a left-side of the electronic gaming device, a right-side of the electronic gaming device, a back-side of the electronic gaming device, and a top of the electronic gaming device and wherein the one or more light emitters are located at least on one of a front-side of the electronic gaming device, a left-side of the electronic gaming device, a right-side of the electronic gaming device, a back-side of the electronic gaming device, and a top of the electronic gaming device.

13. A method of providing game play via an electronic gaming device comprising:
generating one or more presentations on the electronic gaming device; and
generating one or more ambient light shows.

14. The method of claim 13, further comprising interrelating the one or more ambient light shows to the one or more presentations.

15. The method of claim 13, further comprising synchronizing the one or more ambient light shows to the one or more presentations.

16. The method of claim 13, further comprising interrelating at least two of the one or more ambient light shows, the one or more presentations, and an external ambient light show to each other.

17. The method of claim 16, wherein the external ambient light show is generated from one or more external devices.

18. An electronic gaming system comprising:
a server including a server processor and a server memory;
a display device including a plurality of reels, the plurality of reels including one or more areas;
the server memory including one or more ambient lighting modules, one or more presentation modules, and one or more synchronization modules;
one or more ambient light sensors;
one or more light emitters; and
the server processor configured to display one or more presentations and to initiate one or more ambient light shows.

19. The electronic gaming system of claim 18, wherein the server processor is further configured to interrelate the one or more ambient light shows to the one or more presentations.

20. The electronic gaming system of claim 18, wherein the server processor is further configured to synchronize the one or more ambient light shows to the one or more presentations.
